(19) United States
(12) Patent Application Publication
(10) Pub. No.: US 2008/0312382 A1
(43) Pub. Date: Dec. 18, 2008

(54) Polyether Block Copolymers

(76) Inventors: Charles M. Kausch, Copley, OH (US); Yongsin Kim, Hudson, OH (US); Richard R. Thomas, Stow, OH (US); David L. Hardman, JR., Akron, OH (US); Joseph Twitchell, Rock Hill, SC (US)

Correspondence Address: Cheif Intellectual Property Counsel;OMNOVA Solutions Inc., 175 Ghent Road, Fairlawn, OH, 44333-3300, US

(21) Appl. No.: 11/792,980

(22) PCT Filed: Dec. 13, 2005
(86) PCT No.: PCT/US05/44940

§ 371 Date: Apr. 14, 2008

Related U.S. Application Data
(60) Provisional application No. 60/636,049, filed on Dec. 13, 2004.

(51) Int. Cl. C08L 71/02

(52) U.S. Cl. 525/403; 525/50

(57) ABSTRACT

A block copolymer comprising a first polyether block including a pendant alkoxyfluoroalkyl group, and a second polyether block that is substantially devoid of pendant alkoxyfluoroalkyl groups and includes at least two distinct units.

This application is the national phase of International Application No. PCT/US2005/044940, filed on Dec. 13, 2005, which gains the benefit of U.S. Provisional Application No. 60/636,049, filed on Dec. 13, 2004, which is incorporated herein by reference.

### FIELD OF THE INVENTION

This invention relates to polyether block copolymers.

### BACKGROUND OF THE INVENTION

One or more of a wetting, flow, and leveling agent are often added to aqueous compositions. For example, it is common to add wetting, flow, and/or leveling agents to floor polish, aqueous paints, and spin-on coatings such as photo resist compositions, dielectric coatings, and semiconductor cleaning solutions. These wetting, flow, and/or leveling agents often include fluoro surfactants. Many fluorosurfactants, however, tend to foam and/or phase separate. Indeed, anti foam or defoaming agents are often used in conjunction with fluoro surfactants. Depending on the volume of foam and the persistence or duration of the foam, the final coating appearance can be deleteriously impacted. Also, the particle size of certain fluoro surfactants within the aqueous composition can likewise have a deleterious impact on the appearance of the ultimate coating. Also, especially with respect to spin-on coatings, large particles can create a contamination source or location.

There is, therefore, a need for an improved wetting, flow, and/or leveling agent that has less tendency to foam. There is also a need for a wetting, flow, and/or leveling agent that has less tendency to form large particles within aqueous solutions.

### SUMMARY OF THE INVENTION

In general the present invention provides a block copolymer comprising a first polyether block including a pendant alkoxyfluoroalkyl group, and a second polyether block that is substantially devoid of pendant alkoxyfluoroalkyl groups and includes at least two distinct units.

The present invention also includes a method of forming block copolymer, the method comprising providing a polyalkylene oxide copolymer that is substantially devoid of pendant alkoxyfluoroalkyl groups and includes at least two distinct units, and polymerizing cyclic ethers that include pendant alkoxyfluoroalkyl groups in the presence of said polyalkylene oxide copolymer.

The present invention further provides an aqueous composition comprising from about 50 ppm to about 10 weight percent of a block copolymer based upon the total weight of solution, where the block copolymer includes a first polyether block including a pendant alkoxyfluoroalkyl group, and a second polyether block that is substantially devoid of pendant alkoxyfluoroalkyl groups and includes at least two distinct units, and water.

### DETAILED DESCRIPTION OF ILLUSTRATIVE EMBODIMENTS

The present invention provides block copolymers that include a first polyether block including a pendant alkoxyfluoroalkyl group and a second polyether block that is substantially devoid of pendant alkoxyfluoroalkyl groups and includes at least two distinct units (mer units). In one or more embodiments, these block copolymers are advantageously soluble or dispersible in water. Also, in one or more embodiments, these block copolymers advantageously exhibit a reduced tendency to foam (including foam height and foam duration) and are characterized by a reduced particle size at a level greater than the critical micelle concentration.

In one or more embodiments, the first polyether block, which includes at least one pendant alkoxyfluoroalkyl group, includes one or more repeat units defined by the formula

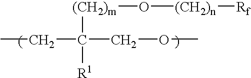

where m is an integer from 1 to about 3, n is an integer from about 0 to 3, R¹ is a hydrogen atom, monovalent organic group, or (CH₂)ₘ—O—(CH₂)ₙ—R_{f}, and R_{f} is a linear or branched alkyl group including 1 to about 20 carbon atoms with at least 25% of the hydrogen atoms being replaced by fluorine. In one or more embodiments, R¹ is selected from hydrogen, methyl, ethyl, and (CH₂)ₘ—O—(CH₂)ₙ—R_{f}, and n is an integer from 1 to about 3.

In one or more embodiments, the divalent organic group may include a hydrocarbylene group or substituted hydrocarbylene group such as, but not limited to, alkylene, cycloalkylene, substituted alkylene, substituted cycloalkylene, alkenylene, cycloalkenylene, substituted alkenylene, substituted cycloalkenylene, arylene, and substituted arylene groups, with each group preferably containing from 1 carbon atom, or the appropriate minimum number of carbon atoms to form the group, up to about 20 carbon atoms. Substituted hydrocarbylene group includes a hydrocarbylene group in which one or more hydrogen atoms have been replaced by a substituent such as an alkyl group. The divalent organic groups may also contain one or more heteroatoms such as, but not limited to, nitrogen, oxygen, boron, silicon, sulfur, and phosphorus atoms.

In one or more embodiments, the monovalent organic groups may include hydrocarbyl groups or substituted hydrocarbyl groups such as, but not limited to alkyl, cycloalkyl, substituted cycloalkyl, alkenyl, cycloalkenyl, substituted cycloalkenyl, aryl, allyl, substituted aryl, aralkyl, alkaryl, and alkynyl groups, with each group preferably containing from 1 carbon atom, or the appropriate minimum number of carbon atoms to form the group, up to 20 carbon atoms. These hydrocarbyl groups may contain heteroatoms such as, but not limited to, nitrogen, boron, oxygen, silicon, sulfur, and phosphorus atoms. In one embodiment, the monovalent organic groups will not react with a living polymer.

In other embodiments, R¹ is selected from hydrogen and methyl. In one or more embodiments, the remaining hydrogen atoms within said R_{f} group may optionally be replaced by other halogen atoms such as iodine, chlorine, or bromine. In one or more embodiments, the R_{f} group includes 1 or 3 or 5 or 7 carbon atoms. In another embodiment, the first polyether block can include units deriving from tetrahydrofuran. In other words, the first polyether block may include a copolymer of the repeat unit described above and tetrahydrofuran (THF). The source of THF can be from the BF₃.THF used as a polymerization catalyst or it can be added deliberately. The level of incorporated THF can be from 1 to about 50 mole percent (optionally about 5 to about 30 mole percent).

The second polyether block, which is substantially devoid of pendant fluoroalkyl groups, includes at least two repeat units defined by the formula

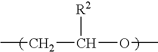

where R² of a first unit is selected from hydrogen or a monovalent organic groups, where R² of a second unit is selected from hydrogen or a monovalent organic group, and where R² of said first unit is distinct from R² of said second unit.

In one or more embodiments, R² is selected from hydrogen, methyl, ethyl, methoxy, and ethoxy groups. In other embodiments, R² is selected from hydrogen and methyl groups.

In one or more embodiments, the units of said second polyether block, which is substantially devoid of pendant alkoxyfluoroalkyl groups, are arranged in block configuration. In other embodiments, these units are arranged in a random or statistical configuration.

In one or more embodiments, the first polyether block (which includes a pendant alkoxyfluoroalkyl group) and the second polyether block (which is substantially devoid of an alkoxyfluoroalkyl groups) may be linked together to form a diblock copolymer. In other embodiments, the blocks may be linked together to form a triblock copolymer. In one embodiment, the first polyether block (which includes pendant alkoxyfluoroalkyl groups) may be at the terminal ends of the block copolymer with the second polyether block (which is substantially devoid of pendant alkoxyfluoroalkyl groups) in the middle of the triblock. This may be referred to as an ABA triblock copolymer.

In other embodiments, a triblock copolymer may include the second polyether blocks (which are substantially devoid of alkoxyfluoroalkyl groups) at the terminal ends of the triblock copolymer with the first polyether block (that which includes a pendant alkoxyfluoroalkyl group) in the middle of the triblock. This triblock copolymer may be referred to as an BAB triblock copolymer.

In one or more embodiments, the block copolymer of this invention is a diblock or triblock copolymer that includes repeat units defined by the formula

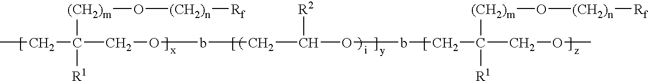

where m, n, R¹, and R_{f} are defined as above, x is an integer from about 1 to about 40, y is 1, and z is an integer from about 0 to about 40, where the sum of x and z is from about 1 to about 80, where i is an integer of from about 2 to about 150, and where R² is selected from hydrogen and monovalent organic groups, with the proviso that at least one i repeat unit includes a first R² and at least one other i repeat unit includes a second R², where said first R² and said second R² are distinct. In one or more embodiments, the first and second R² groups distributed in block, random, or statistical arrangement. As is known in the art, b indicates that the polymer is a block copolymer.

In one or more embodiments, the block copolymer of the present invention can be defined by the formula

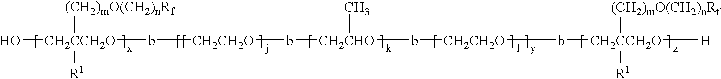

where x is an integer from about 1 to about 40, z is an integer from about 0 to about 40, the sum of x and z is from about 1 to about 80, y is 1, k is an integer from about 1 to about 70, j is an integer from about 1 to about 40, l is an integer from about 0 to about 40, the sum of j and l is about 1 to about 80, and m, n, and R_{f} are as defined above.

In one or more embodiments, the block copolymer of the present invention can be defined by the formula

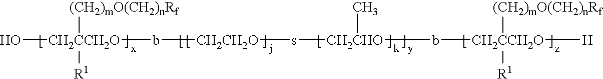

where x is an integer from about 1 to about 20, z is an integer from about 0 to about 20, the sum of x and z is an integer from about 1 to about 40, y is 1, j is an integer from about 1 to about 40, k is an integer from about 1 to about 40, the sum of j and k is 2 to about 80, and m, n, and R_{f} are as defined above.

In one or more embodiments, the block copolymers of this invention may be prepared by polymerizing cyclic ethers that include pendant alkoxyfluoroalkyl groups in the presence of a polyalkylene oxide copolymer initiator. In a manner consistent with the polyether block that is substantially devoid of pendant alkoxyfluoroalkyl groups, the polyalkylene oxide initiator includes at least two distinct repeat units. The polyalkylene oxide can derive from the copolymerization of ethylene oxide and propylene oxide. The repeat units within the polyalkylene oxide can be arranged in a block, random, or statistical manner. Useful polyalkylene oxides are commercially available. For example, polyalkylene block copolymers can be obtained under the tradename PLURONIC™ (BASF). B11-, PR- and/or P41-type polyglycols available from Clariant are additional examples.

Methods for polymerizing cyclic ethers including pendent alkoxyfluoroalkyl groups are known as described in U.S. Pat. Nos. 6,423,418, 6,383,651, 6,579,966, 6,465,565, 6,565,566, which are incorporated herein by reference.

The polyether block copolymers of this invention are useful as at least one of a wetting, flow, and leveling agent in aqueous systems. In one or more embodiments, these polyether block copolymers are useful as fluoro surfactants. While the amount of polyether block copolymer of this invention that is used in various aqueous compositions may vary, it may be useful to employ from about 50 ppm to about 10 wt %, optionally from about 100 ppm to about 5 wt %, and optionally from about 500 ppm to about 1 wt % of the block copolymer of this invention based upon the total weight of aqueous solution.

The polyether block copolymers can have a beneficial impact on several types of aqueous compositions. These aqueous compositions include, but are not limited to, floor polish, aqueous paints, spin-on coatings (e.g., semiconductor cleaning solutions, dielectric compositions, and photo resist compositions), cleaning formulations, leather coatings, and wood coatings.

The polyether block copolymers of the present invention can also be used as wetting, leveling and flow agents in solvent-borne coating systems. Typically, solvent-borne coatings do not suffer from foaming or particle size issues seen with aqueous systems.

In order to demonstrate the practice of the present invention, the following examples have been prepared and tested. The examples should not, however, be viewed as limiting the scope of the invention. The claims will serve to define the invention.

### EXAMPLES

Three block copolymers were prepared and tested for their usefulness in aqueous coatings. In general, these copolymers were prepared by charging a pre-calculated amount of PEO-PPO-PEO block copolymer initiator to a reactor and diluting the same in methylene chloride for Samples 1 and 2. Sample 3 was diluted in a methylene chloride/THF mixture (i.e., 135.24 gram of PEO-PPO-PEO was diluted in 165 gram of methylene chloride and 25 gram of THF). 9.96 gram of BF₃.THF catalyst was then added to the mixture, and the mixture was then stirred for 30 minutes at 35° C. 100 grams of fluorooxetane monomer was then added slowly for about one hour while the mixture was maintained at 40° C. After the addition of the fluorooxetane monomer was complete, the reaction was allowed to proceed for 2 hours while the mixture was maintained at 40° C.

TABLE I

| Sample No. | 1 | 2 | 3 |
|---|---|---|---|
| Center Block | Arch Poly | Arch Poly | BASF Pluronic |
| | G55-112 | G55-156 | L35 |
| | Mw 1,000 | Mw 2,000 | Mw 1,900 |
| | 55% PPO | 55% PPO | 50% PPO |
| Center Block Weight | 41.6 | 58.7 | 57.5 |
| (%) | | | |
| C2F5 | 6 | 6 | 6; 4:1 ratio of |
| poly(fluorooxetane) | | | Fluorooxetane |
| Target degree of | | | monomer-THF |
| polymerization | | | copolymer |
| 1% Aqueous | Cloudy white | Clear, no | Bluish, clear, |
| Solubility | with lots of | sediment; | no sediment |
| | sediment | aggregates | |
| | | over time | |
| Ross-Miles Foam | No foam | 33 mm @ 0 | 1 mm ring @ 0 |
| Height | | min. | min; |
| ASTM D1173-53 | | | 0 mm @ 5 min |
| Equilibrium Surface | 22.50 | 29.05 | 28.59 |
| Tension (mN/m) | | | |

Various modifications and alterations that do not depart from the scope and spirit of this invention will become apparent to those skilled in the art. This invention is not to be duly limited to the illustrative embodiments set forth herein.

What is claimed is:

1. A block copolymer comprising:
a first polyether block including a pendant alkoxyfluoroalkyl group; and
a second polyether block that is substantially devoid of pendant alkoxyfluoroalkyl groups, wherein the second polyether block includes a block copolymer that comprises blocks of at least two distinct units.

2. A method of forming block copolymer, the method comprising:
providing a polyalkylene oxide block copolymer that is substantially devoid of pendant alkoxyfluoroalkyl groups and that comprises blocks of at least two distinct units; and
polymerizing cyclic ethers that include pendant alkoxyfluoroalkyl groups in the presence of said polyalkylene oxide copolymer.

3. A aqueous composition comprising:
from about 50 ppm to about 10 weight percent of a block copolymer based upon the total weight of aqueous solution, where the block copolymer includes:
a first polyether block including a pendant alkoxyfluoroalkyl group; and
a second polyether block that is substantially devoid of pendant alkoxyfluoroalkyl groups, wherein the second polyether block includes a block copolymer that comprises blocks of at least two distinct units.

4. The copolymer of claim 1, or the composition of claim 3, where said first polyether block includes one or more repeat units defined by the formula 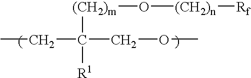
where m is an integer from 1 to about 3, n is an integer from about 0 to 3, R¹ is a hydrogen atom, monovalent organic group, or (CH₂)ₘ—CO—(CH₂)ₙ—R_{f}, and R_{f} is a linear or branched alkyl group including 1 to about 20 carbon atoms with at least 25% of the hydrogen atoms being replaced by fluorine.

5. The copolymer of claim 1, or the composition of claim 3, where said second polyether block includes at least two repeat units defined by the formula 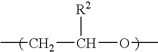
where R² of a first unit is selected from hydrogen or a monovalent organic groups, where R² of a second unit is selected from hydrogen or a monovalent organic group, and where R² of said first unit is distinct from R² of said second unit.

6. The copolymer of claim 1, or the composition of claim 3, where said second polyether block includes ethylene oxide and propylene oxide units.

7. The copolymer of claim 1, method of claim 2, or the composition of claim 3, where the block copolymer includes repeat units defined by the formula 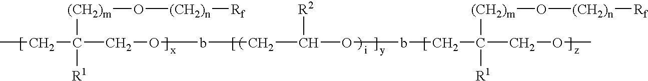
where m is an integer from 1 to about 3, n is an integer from about 0 to 3, R¹ is a hydrogen atom, monovalent organic group, or (CH₂)ₘ—O—(CH₂)ₙ—R_{f}, and R_{f} is a linear or branched alkyl group including 1 to about 20 carbon atoms with at least 250% of the hydrogen atoms being replaced by fluorine, x is an integer from about 1 to about 40, y is 1, and z is an integer from about 0 to about 40, where the sum of x and z is from about 1 to about 80, where i is an integer of from about 2 to about 150, and where R² is selected from hydrogen and monovalent organic groups, with the proviso that least one i repeat unit includes a first R² and at least one other i repeat unit includes a second R², where said first R² and said second R² are distinct.

8. The copolymer of claim 1, method of claim 2, or the composition of claim 3, where the block copolymer is defined by the formula 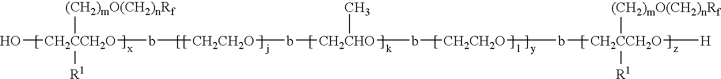
where x is an integer from about 1 to about 40, z is an integer from about 0 to about 40, the sum of x and z is from about 1 to about 80, y is 1, k is an integer from about 1 to about 70, j is an integer from about 1 to about 40, l is an integer from about 0 to about 40, the sum of j and 1 is about 1 to about 80, and where m is an integer from 1 to about 3, n is an integer from about 0 to 3, R¹ is a hydrogen atom, monovalent organic group, or (CH₂)ₘ—O—(CH₂)ₙ—R_{f}, and R_{f} is a linear or branched alkyl group including 1 to about 20 carbon atoms with at least 25% of the hydrogen atoms being replaced by fluorine.

9. The copolymer of claim 1, method of claim 2, or the composition of claim 3, where the block copolymer is defined by the formula 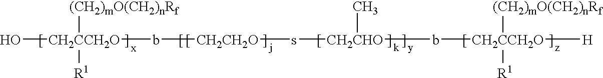
where x is an integer form about 1 to about 20, z is an integer from about 0 to about 20, the sum of x and z is an integer from about 1 to about 40, y is 1, j is an integer from about 1 to about 40, k is an integer from about 1 to about 40, the sum of j and k is 2 to about 80, and where m is an integer from 1 to about 3, n is an integer from about 0 to 3, R¹ is a hydrogen atom, monovalent organic group, or (CH₂)ₘ—O—(CH₂)ₙ—R_{f}, and R_{f} is a linear or branched alkyl group including 1 to about 20 carbon atoms with at least 25% of the hydrogen atoms being replaced by fluorine.

10. The copolymer of claim 1, or the composition of claim 3, where said first polyether block includes 1 to about 50 mole percent units deriving from THF.

11. The copolymer of claim 1, or the composition of claim 3, where said second polyether block includes at least two repeat units defined by the formula 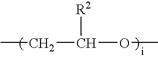
where R² of a first unit is selected from hydrogen or a monovalent organic groups, where R² of a second unit is selected from hydrogen or a monovalent organic group, where R² of said first unit is distinct from R² of said second unlit and where each i is independently an integer of from about 2 to about 150.

12. The method of claim 2, where said polyalkylene oxide block copolymer includes at least two repeat units defined by the formula 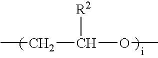
where R² of a first unit is selected from hydrogen or a monovalent organic groups, where R² of a second unit is selected from hydrogen or a monovalent organic group, where R² of said first unit is distinct from R² of said second unit, and where each i is independently an integer of from about 2 to about 150.

13. The method of claim 2, where said step of polymerizing occurs in an aqueous solution comprising from about 50 ppm to about 10 wt. % of the polyalkylene oxide block copolymer, based upon the coral weight of the aqueous solution.

14. The copolymer of claim 1, or the composition of claim 3, where said second polyether block includes a sub-block of ethylene oxide units and a sub-block of propylene oxide units.
